(19) United States
(12) Patent Application Publication
(10) Pub. No.: US 2016/0059968 A1
(43) Pub. Date: Mar. 3, 2016

(54) METHOD AND DEVICE FOR DISTINGUISHING BETWEEN THE IN-FLIGHT STATUS AND THE ON-GROUND STATUS OF AN AIRCRAFT

(71) Applicant: Airbus Operations GmbH, Hamburg (DE)

(72) Inventors: Kai Bredemeier, Hamburg (DE); Carsten Heuer, Hamburg (DE)

(21) Appl. No.: 14/837,152

(22) Filed: Aug. 27, 2015

(30) Foreign Application Priority Data
Aug. 27, 2014 (EP) 14182549.7

(51) Int. Cl. B64D 45/00; B64C 1/14

(52) U.S. Cl. CPC B64D 45/00; B64C 1/1423

(57) ABSTRACT

The disclosure herein relates to a method and device for distinguishing between in-flight status and on-ground status of an aircraft, wherein the interior of a fuselage is pressurized in flight status. The deformation of a fuselage section is monitored, and a signal is generated dependent on such deformation.

### CROSS-REFERENCE TO RELATED APPLICATION

This application claims priority to European Patent Application No. 14182549.7 filed Aug. 27, 2014, the entire disclosure of which is incorporated by reference herein.

### TECHNICAL FIELD

The disclosure herein relates to a method and device for distinguishing between the in-flight status and the on-ground status of an aircraft, wherein the interior of its fuselage is pressurized during the in-flight status.

### BACKGROUND

In commercial aircraft, the interior of the fuselage is pressurized during flight and only during flight. Information about the status of the aircraft is required for a plurality of purposes, e.g. to initiate a warning when attempting to open a door during the in-flight status (which in fact means that the cabin is pressurized), or to initiate a warning when attempting to open a door with armed slides or prevent inadvertent slide deployment during the on-ground status (which in fact means that the cabin is not pressurized).

Presently, such information is obtained by signals generated e.g. by the aircraft engines and/or by the landing gear. In addition, it is known to use a differential pressure switch connected to the pipe system of the so-called Integrated Standby Instrument System to provide a status signal depending on the pressure difference between the inside and the outside of the aircraft.

Generation of the corresponding signal of the differential pressure switch is effective, but requires considerable wiring including connectors to transmit such signal to all doors of the aircraft fuselage. The same applies to the use of the corresponding signals generated by the engines or by the landing gear for in-flight status and on-ground status evaluation.

### SUMMARY

It is an object of the disclosure herein to provide for a simplified method and device for distinguishing between in-flight status and on-ground status of an aircraft.

Such an object is achieved according to the disclosure herein by monitoring a deformation of a fuselage section and generating a signal dependent on such deformation, wherein preferably such signal is generated upon detecting a predetermined deformation. The signal is a status signal which indicates whether the aircraft is currently in in-flight status or in on-ground status, i.e. whether the aircraft is currently in flight or on the ground.

By using detection of deformation of a fuselage section an indication is obtained whether the aircraft is in in-flight status or in ground status, since pressurizing and depressurizing of the interior of the fuselage is effected by signals from other sources.

The signal generated according to the disclosure herein may, e.g., also be used to control an optical indicator, such as the differential pressure warning light (i.e. a warning light indicating the presence of a differential pressure between the interior of the aircraft and the exterior of the aircraft or that a certain threshold has been exceeded for that differential pressure) and/or the slide armed warning light (i.e. a warning light indicating that a slide associated with a door is armed) of one or more doors in the fuselage. Additionally or alternatively, the signal generated according to the disclosure herein may also be used to contribute to prevention of opening doors on ground whilst the fuselage is pressurized or is subject to a (minimum) differential pressure and/or to contribute to prevention of inadvertent slide deployments.

In any case, use of the information obtained by monitoring deformation of a fuselage section renders it possible to minimize the wiring length between such fuselage section and the items to be controlled by the signal generated, e.g. the optical indicator such as the differential pressure warning light and/or the slide armed warning light, and to thereby reduce the wiring required.

The signal of interest may be generated e.g. by one or more resistance strain gauges or by at least one optical sensor. This generation may occur directly or via an evaluation device or evaluator, which is adapted to receive sensor signals from the at least one resistance strain gauge or the at least one optical sensor, to generate the signal of interest on the basis of the sensor signals.

When conducting the method according to the disclosure herein by resistance strain gauges, one or more resistance strain gauges may be mounted on a flexible board spaced from each other, which board is fixed to the fuselage section. Thus, upon deformation of the fuselage section, the board is also deformed, and this deformation is detected by the resistance strain gauges. However, it is preferred that one or more resistance strain gauges are mounted spaced from each other directly to the fuselage section. In that case the resistance strain gauges directly detect the deformation of the fuselage section.

When using an optical sensor, a suitable optical sensor may comprise an optical transmitter and an optical multiple receiver attached to a flexible carrier or circuit board or the like, wherein the flexible carrier or circuit board or the like is fixed to the corresponding fuselage section, possibly via an adapter or intermediate piece providing a planar surface for the flexible carrier or circuit board or the like in the non-deformed state of the fuselage section. Upon deformation of the section and thus the flexible carrier or circuit board or the like, the positions or relative orientations of the optical transmitter and of the multiple receiver change with respect to each other so that the light beam emitted by the optical transmitter is received by another part of the multiple receiver. This provides an indication of the deformation. The multiple receiver may comprise multiple distinct light sensing fields or receiver parts and allow to distinguish which of the sensing fields or receiver parts currently receive the light beam emitted by the optical transmitter. The optical sensor may comprise a housing in which the optical transmitter, the optical multiple receiver and the flexible carrier or circuit board or the like are disposed in order to provide protection against the environment. In any case, the optical sensor is preferably provided as a unit.

The fuselage section referred to above may be, for example, a part of a door or another portion of a fuselage of an aircraft.

### BRIEF DESCRIPTION OF THE DRAWINGS

The disclosure herein will be described in the following in more detail with respect to the drawings showing schematically an embodiment.

FIG. 1 shows in principle the skin portion of an aircraft door including window opening.

FIG. 2 shows in principle an optical sensor comprising a flexible board, which board is shown in non-deformed and in deformed state.

### DETAILED DESCRIPTION

The skin portion 1 of an aircraft door comprises the usual window cutout 2. On this skin portion, positions for deformation sensors 3 are indicated. These sensors may e.g. be resistance strain gauges electrically connected to a corresponding evaluation circuit (not shown) provided in the aircraft door. The circuit is connected to a power supply and may in addition be connected to a battery pack to be activated upon failure of the power supply. Thus, a device for generating signals for representing the in-flight status and the on-ground status of the aircraft can be located locally in each door to control e.g. the differential pressure warning light and/or the slide armed warning light of the door without having to rely on signals generated by other sources located more centrally in the aircraft. The signals generated by the methods and devices may also contribute to the prevention of inadvertent slide deployments.

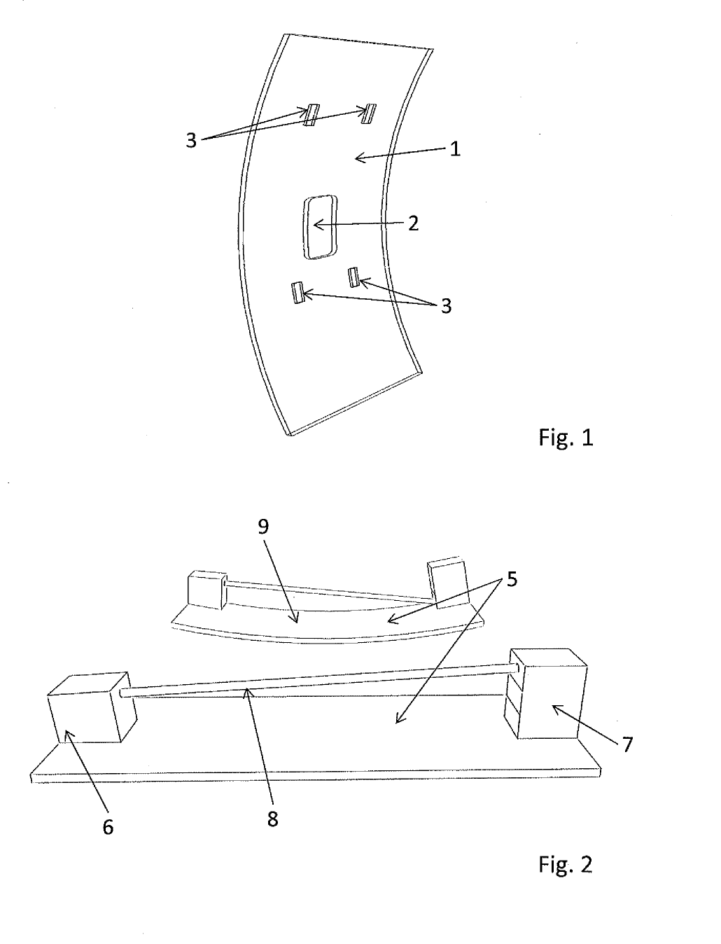

Rather than using pairs of resistance strain gauges 3, as indicated in FIG. 1, one or more optical sensors may be used, as shown in principle in FIG. 2 (housing of the sensor not shown). Such an optical sensor is of conventional structure and comprises a transmitter 6 and a multiple receiver 7, both attached to a flexible board 5 and spaced from each other. The board 5 is attached to the skin portion 1 of the door so that upon deformation of the skin portion the board 5 deforms correspondingly, as indicated in the upper portion of FIG. 2 by deformation 9.

In the on-ground status of the aircraft the board 5 is not deformed and, as indicated in the lower portion of FIG. 2, the light beam 8 emitted by the transmitter 6 is received by the upper section of the multiple receiver 7. Upon deformation of the board 5 in in-flight status, the light beam 8 moves from the upper section of the receiver 7 to a lower section which provides not only an indication as to deformation of the board 5 and, therefore, of the skin portion 1 of the aircraft door, but also an indication as to the degree of deformation.

While at least one exemplary embodiment for a method and device of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of distinguishing between in-flight status and on-ground status of an aircraft, wherein the interior of a fuselage is pressurized in in-flight status, comprising monitoring deformation of a fuselage section and generating a signal dependent on such deformation.

2. The method according to claim 1, wherein the signal is generated upon detecting a predetermined deformation.

3. The method according to claim 1, wherein the section forms part of a door of the fuselage.

4. The method according to claim 1, wherein the signal is used to activate an optical indicator in passenger doors.

5. The method according to claim 1, wherein the signal is used to contribute to prevention of opening at least one door in on-ground status while the fuselage is pressurized and/or to contribute to prevention of inadvertent slide deployments.

6. The method according to claim 1, wherein the signal is generated by at least one resistance strain gauge.

7. The method according to claim 1, wherein the signal is generated by at least one optical sensor.

8. A device for distinguishing between in-flight status and on-ground status of an aircraft, wherein the interior of a fuselage is pressurized in in-flight status, the device comprising a sensor arrangement, which includes at least one sensor secured to a fuselage section of an aircraft and is adapted to generate a sensor signal which depends on a deformation of the fuselage section, and an evaluator operably connected to the sensor arrangement and adapted to receive the sensor signal and to generate, based on the sensor signal, a status signal indicating whether the aircraft is in in-flight status or in on-ground status.

9. The device according to claim 8, wherein the device is adapted for the signal to be generated by at least one resistance strain gauge, and wherein at least two resistance strain gauges are mounted spaced from each other on the fuselage section or on a flexible board which is fixed to the fuselage section.

10. The device according to claim 8, wherein the device is adapted for the signal to be generated by at least one optical sensor, and wherein an optical sensor, which comprises an optical transmitter and an optical multiple receiver mounted on a flexible carrier spaced from each other, is fixed to the fuselage section.
